(19) United States
(12) Patent Application Publication
(10) Pub. No.: US 2026/0241518 A1
(43) Pub. Date: Aug. 20, 2026

(54) VACUUM CHUCK WITH BELLOW CAPS

(71) Applicant: KLA Corporation, Milpitas, CA (US)

(72) Inventors: Stephen Sidletsky, Redwood City, CA (US); Michel Pharand, Los Gatos, CA (US); Mychau Lu, San Jose, CA (US)

(21) Appl. No.: 19/467,075

(22) Filed: Feb. 2, 2026

Related U.S. Application Data
(60) Provisional application No. 63/756,833, filed on Feb. 11, 2025.

(51) Int. Cl. B25B 11/00; B23Q 3/08

(52) U.S. Cl. CPC B25B 11/005; B23Q 3/088

(57) ABSTRACT

A vacuum chuck includes a chuck body having a planar surface configured to support a workpiece and a plurality of apertures defined in the planar surface. A plurality of bellows are disposed within the plurality of apertures, each being compressible to protrude from the planar surface in an uncompressed state and recess from the planar surface in a compressed state. A plurality of caps are disposed on the plurality of bellows and are substantially coplanar with the planar surface in the compressed state. An opening is defined in a top surface of each cap. At least one vacuum source is in fluid communication with the plurality of apertures of the chuck body and the opening of each cap to apply negative pressure to compress the plurality of bellows into the compressed state and flatten the workpiece onto the planar surface of the chuck body due to engagement with each cap.

### CROSS-REFERENCE TO RELATED APPLICATIONS

This application claims priority to U.S. Application No. 63/756,833, filed Feb. 11, 2025, the entire disclosure of which is hereby incorporated by reference.

### FIELD OF THE DISCLOSURE

This disclosure relates to semiconductor fabrication and inspection and, more particularly, to a chuck configured to support a semiconductor wafer during fabrication and inspection.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes are used at various steps during semiconductor manufacturing to monitor and control the process. Metrology processes are different than inspection processes in that, unlike inspection processes in which defects are detected on wafers, metrology processes are used to measure one or more characteristics of the wafers that cannot be determined using existing inspection tools. Metrology processes can be used to measure one or more characteristics of wafers such that the performance of a process can be determined from the one or more characteristics. For example, metrology processes can measure a dimension (e.g., line width, thickness, etc.) of features formed on the wafers during the process. In addition, if the one or more characteristics of the wafers are unacceptable (e.g., out of a predetermined range for the characteristic(s)), the measurements of the one or more characteristics of the wafers may be used to alter one or more parameters of the process such that additional wafers manufactured by the process have acceptable characteristic(s).

One of the challenges for metrology and inspection systems is to perform accurate measurements in the presence of local wafer tilt. Wafer tilt can develop due to inherent tilt arising from mechanical limitations and tilt due to wafer related properties such as thickness gradients or backside particles. Model-based methods suffer from the impact of changing under-angle (CUA) on the measurements. While machine learning algorithms can attempt to filter the signals from the ellipsometer or the reflectometer to compensate for wafer tilt, these methods can have low accuracy. Other methods rely on a mechanical chuck to flatten the wafer and avoid wafer tilt. For example, the chuck may have elastomeric bellows that contact the back side of the wafer and flatten the waver onto the chuck using vacuum force. However, the contact between the bellows and the wafer can cause large particles build-up over time, which can impact other semiconductor manufacturing processes. In addition, if all the bellows don't properly seal against the back side of the wafer (e.g., for highly bowed wafers), generating a pressure differential across the wafer can be difficult, which reduces the chuck efficiency. Lastly, bellows that protrude above the wafer plane would cause collision with the optics when performing calibration without a wafer.

Therefore, what is needed is an improved vacuum chuck for reducing wafer tilt that avoids one or more of the challenges described above.

### BRIEF SUMMARY OF THE DISCLOSURE

An embodiment of the present disclosure provides a vacuum chuck. The vacuum chuck may comprise a chuck body having a planar surface and a plurality of apertures defined in the planar surface. The planar surface may be configured to support a workpiece. The vacuum chuck may further comprise a plurality of bellows disposed within the plurality of apertures. The plurality of bellows may be compressible such that the plurality of bellows protrude from the planar surface in an uncompressed state and are recessed from the planar surface in a compressed state. The vacuum chuck may further comprise a plurality of caps disposed on the plurality of bellows. An opening may be defined in a top surface of each cap. The plurality of caps may be substantially coplanar with the planar surface in the compressed state. The vacuum chuck may further comprise at least one vacuum source in fluid communication with the plurality of apertures of the chuck body and the opening of each cap. The at least one vacuum source may be configured to apply negative pressure to compress the plurality of bellows into the compressed state and flatten the workpiece onto the planar surface of the chuck body due to engagement with each cap.

In some embodiments, the plurality of caps may be made of an elastomeric material.

In some embodiments, a primary vacuum channel may be defined in the chuck body.

The at least one vacuum source may be in fluid communication with the plurality of apertures and the opening of each cap via the primary vacuum channel.

In some embodiments, a secondary vacuum channel may be further defined in the chuck body. The at least one vacuum source may be in fluid communication with an external volume defined by an interior surface of the plurality of apertures and an exterior surface of the plurality of bellows via the secondary vacuum channel.

In some embodiments, the external volume may be sealed from the planar surface of the chuck body by the plurality of caps in the compressed state. The external volume may be open to the planar surface in the uncompressed state.

In some embodiments, the plurality of apertures may be counterbores, each defining an annular bearing surface, and a bottom surface of each cap rests on the annular bearing surface in the compressed state to seal the external volume from the planar surface of the chuck body in the compressed state.

In some embodiments, the at least one vacuum source may comprise a first vacuum source in fluid communication with the primary vacuum channel. The at least one vacuum source may further comprise a second vacuum source in fluid communication with the secondary vacuum channel. The second vacuum source may be configured to apply negative pressure to compress the plurality of bellows into the compressed state without a workpiece disposed on the planar surface of the chuck body.

In some embodiments, the at least one vacuum source may be further configured to apply negative pressure through the secondary vacuum channel to simultaneously compress the plurality of bellows into the compressed state without a workpiece disposed on the planar surface of the chuck body.

In some embodiments, an internal volume may be defined in each of the plurality of bellows. The opening of each cap may be in fluid communication with the primary vacuum channel via the internal volume of each bellow.

In some embodiments, a plurality of orifices may be further defined in the chuck body. The plurality of orifices may connect each of the plurality of openings to the primary vacuum channel. The plurality of orifices may be configured to restrict flow from the plurality of openings to the primary vacuum channel.

In some embodiments, the plurality of orifices may be further configured to isolate each opening as each cap non-simultaneously engages with the workpiece and each bellow individually compresses to the compressed state.

Another embodiment of the present disclosure provides a method. The method may comprise providing a vacuum chuck. The vacuum chuck may comprise a chuck body having a planar surface and a plurality of apertures defined in the planar surface. The planar surface may be configured to support a workpiece. The vacuum chuck may further comprise a plurality of bellows disposed within the plurality of apertures. The plurality of bellows may be compressible such that the plurality of bellows protrude from the planar surface in an uncompressed state and are recessed from the planar surface in a compressed state. The vacuum chuck may further comprise a plurality of caps disposed on the plurality of bellows. An opening may be defined in a top surface of each cap. The plurality of caps may be substantially coplanar with the planar surface in the compressed state. The vacuum chuck may further comprise at least one vacuum source in fluid communication with the plurality of apertures of the chuck body and the opening of each cap.

The method may further comprise disposing the workpiece on the planar surface of the chuck body in contact with the plurality of caps. The method may further comprise controlling the at least one vacuum source to apply negative pressure to compress the plurality of bellows into the compressed state and flatten the workpiece onto the planar surface of the chuck due to engagement with each cap.

In some embodiments, a primary vacuum channel may be defined in the chuck body, and the at least one vacuum source may be in fluid communication with the plurality of apertures and the opening of each cap via the primary vacuum channel.

In some embodiments, before disposing the workpiece on the planar surface of the chuck body in contact with the plurality of caps, the method may further comprise controlling the at least one vacuum source to apply negative pressure through a secondary vacuum channel to simultaneously compress the plurality of bellows into the compressed state without a workpiece disposed on the planar surface of the chuck body. The secondary vacuum channel may be defined in the chuck body such that the at least one vacuum source is in fluid communication with an external volume defined by an interior surface of the plurality of apertures and an exterior surface of the plurality of bellows via the secondary vacuum channel.

In some embodiments, the external volume may be sealed from the planar surface of the chuck body by the plurality of caps in the compressed state, and the external volume may be open to the planar surface in the uncompressed state.

In some embodiments, the plurality of apertures may be counterbores, each defining an annular bearing surface, and a bottom surface of each cap rests on the annular bearing surface in the compressed state to seal the external volume from the planar surface of the chuck body in the compressed state.

In some embodiments, the at least one vacuum source may be controlled to apply negative pressure through the secondary vacuum channel to simultaneously compress the plurality of bellows into the compressed state without a workpiece disposed on the planar surface of the chuck.

In some embodiments, an internal volume may be defined in each of the plurality of bellows, the opening of each cap may be in fluid communication with the primary vacuum channel via the internal volume of each bellow.

In some embodiments, a plurality of orifices may be further defined in the chuck body, the plurality of orifices may connect each of the plurality of openings to the primary vacuum channel and may be configured to restrict flow from the plurality of openings to the primary vacuum channel.

In some embodiments, the plurality of orifices may be further configured to isolate each opening as each cap non-simultaneously engages with the workpiece and each bellow individually compresses to the compressed state.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a vacuum chuck according to an embodiment of the present disclosure;

FIG. 2A is a cross-sectional view of a vacuum chuck according to another embodiment of the present disclosure having a workpiece disposed thereon and the plurality of bellows thereof shown in an uncompressed state;

FIG. 2B is a cross-sectional view of the vacuum chuck of FIG. 2A with the plurality of bellows thereof shown in a compressed state to flatten the workpiece onto the vacuum chuck;

FIG. 3A is a cross-sectional view of the vacuum chuck of FIG. 2A having no workpiece disposed thereon and the plurality of bellows thereof shown in an uncompressed state;

FIG. 3B is a cross-sectional view of the vacuum chuck of FIG. 3A with the plurality of bellows thereof shown in a compressed state;

FIG. 4A is a detailed cross-sectional view of a vacuum chuck according to an embodiment of the present disclosure with one of the plurality of bellows thereof in an uncompressed state;

FIG. 4B is a detailed cross-sectional view of the vacuum chuck of FIG. 4A with one of the plurality of bellows thereof shown in a compressed state;

FIG. 5 is a flowchart of a method according to an embodiment of the present disclosure; and

FIG. 6 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

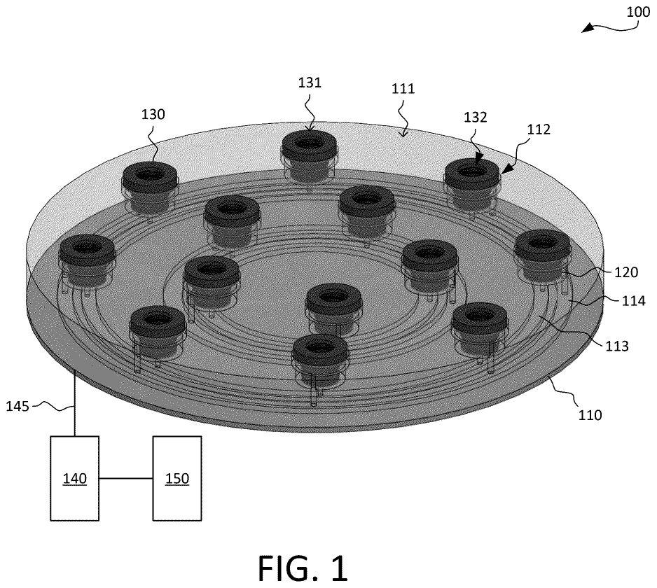

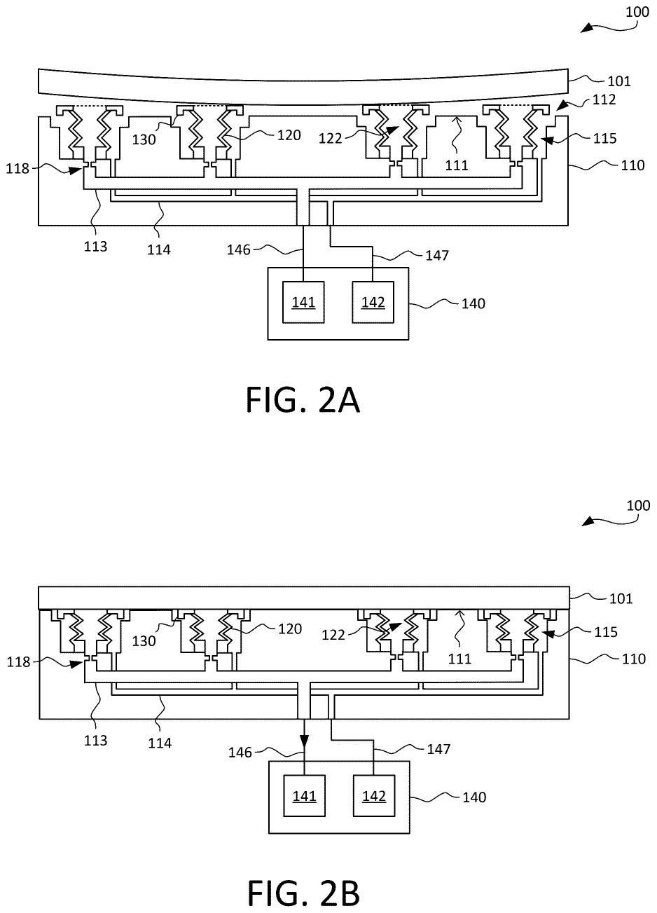

An embodiment of the present disclosure provides a vacuum chuck 100, as shown in FIG. 1. The vacuum chuck 100 may be, for example, part of a fabrication, inspection, or metrology system configured to perform one or more fabrication, inspection, or metrology processes on a workpiece 101 (shown in FIGS. 2A and 2B) supported by the vacuum chuck 100. The workpiece 101 may be, for example, a semiconductor wafer, substrate, printed circuit board (PCB), chip, integrated circuit (IC), flat panel display (FPD), or other type of workpiece. The workpiece 101 can be warped/bowed in a convex, concave, or other complex shapes like a saddle or potato chip, one example of which is shown in FIG. 2A). The warp/bow of the workpiece 101 may be, for example, as low as 10-20 μm to up to 10 mm, though other values are possible.

The vacuum chuck 100 may comprise a chuck body 110. The chuck body 110 may have a planar surface 111 and a plurality of apertures 112 defined in the planar surface 111. The plurality of apertures 112 may be arranged in the planar surface 111 in a rectangular or circular array, and may be evenly or unevenly spaced across the planar surface 111. The planar surface 111 may be configured to support the workpiece 101. For example, the vacuum chuck 100 may be configured to flatten the workpiece 101 against the planar surface 111 of the chuck body 110 to reduce wafer tilt for performing fabrication, inspection, or metrology processes, as further explained below. The planar surface 111 may be circular, rectangular, or other shapes, depending on the shape of the workpiece 101 to be supported by the planar surface 111. Circular workpieces can range from 100 mm to 300 mm in diameter. Square or rectangular workpieces can range from 310 mm×310 mm to 510 mm×510 mm. Accordingly, the planar surface 111 of the chuck body 110 may be at least as large these ranges of sizes of the workpiece 101.

The vacuum chuck 100 may further comprise a plurality of bellows 120. The plurality of bellows 120 may be disposed within the plurality of apertures 112 of the chuck body 110. The plurality of bellows 120 may be compressible such that the plurality of bellows 120 may protrude from the planar surface 111 in an uncompressed state and may be recessed from the planar surface 111 in a compressed state. The compressibility of the plurality of bellows 120 and distance that the plurality of bellows 120 protrude from the planar surface 111 of the chuck body 110 may allow the plurality of bellows 120 to engage with the workpiece 101 at different distances despite large warp/bow in the workpiece 101. The plurality of bellows 120 may have a low modulus of elasticity, for example, 0.1 MPa to 10 MPa. In some embodiments, the plurality of bellows 120 may be made of silicon, vinyl, buna n (nitrile rubber), or other materials.

The vacuum chuck 100 may further comprise a plurality of caps 130. The plurality of caps 130 may be disposed on the plurality of bellows 120. For example, the plurality of caps 130 may be bonded to or otherwise secured to the plurality of bellows 120. The plurality of caps 130 may be made of an elastomeric material (e.g., Ertalyt) that produces a low amount of particles from contact with the workpiece 101. In some embodiments, the plurality of caps 130 may be made of other materials used for wafer chucks, such as, for example, aluminum or silicon carbide. A low friction coating can be added to side walls of the plurality of caps 130 to reduce particles and improve reliability. An opening 132 may be defined in a top surface 131 of each cap 130. The opening 132 may be, for example, a circular opening extending through the cap 130. The size of the opening 132 may be large enough to not restrict vacuum flow, but no larger than the sealing ring of the plurality of bellows 120. The plurality of caps 130 may be substantially coplanar with the planar surface 111 in the compressed state of the plurality of bellows 120, as shown in FIG. 2B. In other words, the top surface 131 of each cap 130 may be substantially coplanar with the planar surface 111 of the chuck body 110 in the compressed state of the plurality of bellows 120. In the uncompressed state of the plurality of bellows 120, the plurality of caps 130 may at least partially protrude from the planar surface 111, as shown in FIG. 2A. In other words, while the top surface 131 of each cap 130 protrudes from the planar surface 111 in the uncompressed state of the plurality of bellows 120, a remaining part of each cap 130 may remain recessed from the planar surface 111 or may also protrude from the planar surface 111, depending on a thickness of the cap 130 and the geometry of the plurality of apertures 112 of the chuck body 110. In general, a portion of each cap 130 remaining recessed from the planar surface 111 in the uncompressed state can aid in guiding the motion of the plurality of bellows 120 in the plurality of apertures 112 to the compressed state.

The vacuum chuck 100 may further comprise at least one vacuum source 140. The at least one vacuum source 140 may be in fluid communication with the plurality of apertures 112 of the chuck body 110 and the opening 132 of each cap 130. For example, the at least one vacuum source 140 may be provided within the chuck body 110 or separate from the chuck body 110 and in fluid communication with the plurality of apertures 112 of the chuck body 110 and the opening 132 of each cap 130 via one or more vacuum lines 145. The at least one vacuum source 140 may be configured to apply negative pressure to compress the plurality of bellows 120 into the compressed state and flatten the workpiece 101 onto the planar surface 111 of the chuck body 110 due to engagement with each cap 130, as shown in FIG. 2B. The at least one vacuum source 140 may include one or more valves configured to control vacuum flow through the one or more vacuum lines 145 and through the plurality of apertures 112 of the chuck body 110 and the opening 132 of each cap 130.

In some embodiments, a primary vacuum channel 113 may be defined in the chuck body 110. The at least one vacuum source 140 may be in fluid communication with the plurality of apertures 112 and the opening 132 of each cap 130 via the primary vacuum channel 113. For example, the one or more vacuum lines 145 may comprise a primary vacuum line 146 in fluid communication with the primary vacuum channel 113, which is in fluid communication with the plurality of apertures 112 and the opening 132 of each cap 130. An internal volume 122 may be defined in each of the plurality of bellows 120. The opening 132 of each cap 130 may be in fluid communication with the primary vacuum channel 113 via the internal volume 122 of each bellow 120. The vacuum flow rate through the primary vacuum channel 113 may be, for example, less than 60 SLM, due to the improved sealing between the plurality of caps 130 and the back side of the workpiece 101. In some embodiments, the vacuum flow rate can be as low as 10 SLM with an appropriately sized orifice 118 (further described below) without impacting the maximum warpage of the workpiece 101 supported.

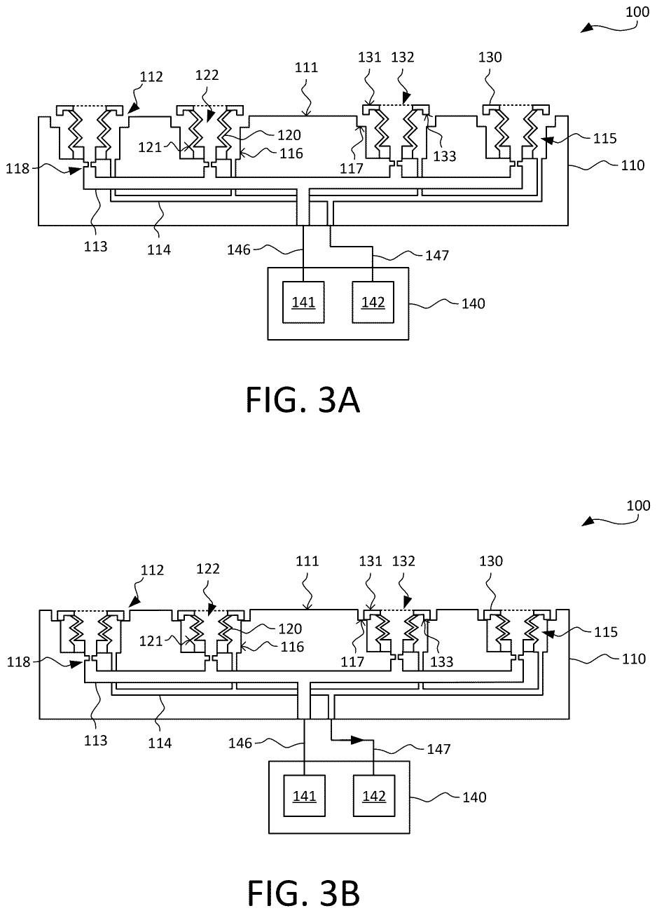

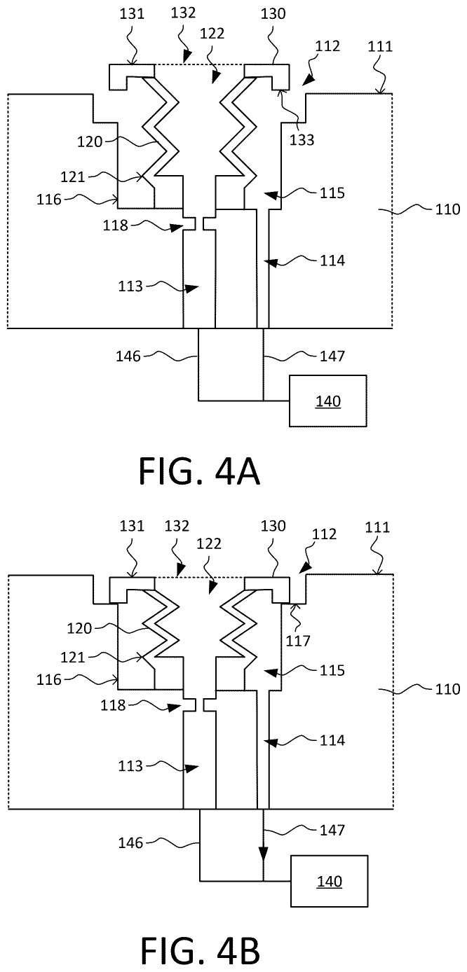

In some embodiments, a secondary vacuum channel 114 may be further defined in the chuck body 110. The at least one vacuum source 140 may be in fluid communication with an external volume 115 defined by an interior surface 116 of the plurality of apertures 112 and an exterior surface 121 of the plurality of bellows 120 via the secondary vacuum channel 114 (as shown in FIGS. 3A and 3B). For example, the one or more vacuum lines 145 may further comprise a secondary vacuum line 147 in fluid communication with the secondary vacuum channel 114 which is in fluid communication with the external volume 115 defined by the interior surface 116 of the plurality of apertures 112 and the exterior surface 121 of the plurality of bellows 120. The external volume 115 may be sealed from the planar surface 111 of the chuck body 110 by the plurality of caps 130 in the compressed state. For example, the plurality of apertures 112 defined in the planar surface 111 of the chuck body 110 may be counterbores, each defining an annular bearing surface 117. A bottom surface 133 of each cap 130 may rest on the annular bearing surface 117 in the compressed state to seal the external volume 115 from the planar surface 111 of the chuck body 110 in the compressed state (as shown in FIG. 4B). The external volume 115 may be open to the planar surface 111 in the uncompressed state (as shown in FIG. 4A). In other words, the external volume 115 may be in fluid communication a corresponding one of the plurality of apertures 112 in the uncompressed state. The at least one vacuum source 140 may be further configured to apply negative pressure through the secondary vacuum channel 114 to simultaneously compress the plurality of bellows 120 into the compressed state without a workpiece 101 disposed on the planar surface 111 of the chuck body 110 (as shown in FIGS. 3A and 3B). For example, the negative pressure applied through the secondary vacuum channel 114 may draw air through the plurality of apertures 112 and through the external volume 115, such that the plurality of bellows are compressed into the compressed state. The vacuum flow rate through the secondary vacuum channel 114 may be, for example, 10 to 120 SLM. In some embodiments, the vacuum flow rate may be about 30 to 40 SLM. In general, minimizing the external volume 115 may reduce the actuation time of compressing the plurality of bellows 120 into the compressed state.

In some embodiments, the at least one vacuum source 140 may comprise a first vacuum source 141 in fluid communication with the primary vacuum channel 113. In some embodiments, the at least one vacuum source 140 may further comprise a second vacuum source 142 in fluid communication with the secondary vacuum channel 114. The second vacuum source 142 may be configured to apply negative pressure to compress the plurality of bellows 120 into the compressed state without a workpiece 101 disposed on the planar surface 111 of the chuck body 110. In general, the use of separate vacuum sources for the primary vacuum channel 113 and the secondary vacuum channel 114 can allow both to be used at the same time without any cross-talk between them.

In some embodiments, the at least one vacuum source 140 may comprise only the first vacuum source 141, which may be in fluid communication with the primary vacuum channel 113 and the secondary vacuum channel 114, and the first vacuum source 141 may comprise one or more valves configured to control vacuum flow through the primary vacuum channel 113 and the secondary vacuum channel 114. Accordingly, the first vacuum source 141 may be configured to apply negative pressure through the primary vacuum channel 113 to compress the plurality of bellows 120 into the compressed state and flatten the workpiece 101 onto the planar surface 111 of the chuck body 110 due to engagement with each cap 130, and the first vacuum source 141 may be further configured to apply negative pressure through the secondary vacuum channel 114 to simultaneously compress the plurality of bellows 120 into the compressed state without a workpiece 101 disposed on the planar surface 111 of the chuck body 110.

In some embodiments, a plurality of orifices 118 may be further defined in the chuck body 110. The plurality of orifices 118 may connect each of the plurality of openings 132 of the plurality of caps 130 to the primary vacuum channel 113 (e.g., via the internal volume 122 of each of the plurality of bellows 120). The plurality of orifices 118 may be configured to restrict flow from the plurality of openings 132 to the primary vacuum channel 113. The plurality of orifices 118 may be further configured to isolate each opening 132 as each cap 130 non-simultaneously engages with the workpiece 101 and each bellow 120 individually compresses to the compressed state. For example, in a situation where each of the plurality of bellows 120 do not simultaneously engage with the bottom surface of the workpiece 101 (e.g., due to significant bow), the plurality of orifices 118 may prevent cross talk between the plurality of bellows 120, allowing each bellow 120 to independently seal with the bottom surface of the workpiece 101 which improves chucking performance of the vacuum chuck 100.

Flattening a semiconductor wafer on a chuck can be accomplished in several ways, e.g., using perimeter seals or bellows. Because of front side films depositions on a semiconductor wafer performed at temperatures higher than ambient, the coefficient of thermal expansion between the wafer and the film can lead to wafer bow. Wafer bow can be as large as 4 mm. For this reason, using a bellows approach to create regions where a pressure differential is generated, Force=ΔP*Area. The force multiplied by a moment arm is used to flatten the wafer against the wafer chuck. The wafer can then be processed on a tool.

Semiconductor tool productivity is an important attribute. When using bellows with high bow wafers, the chucking process could be slower than other methods. For the wafer to get flattened, all bellows must contact the wafer, if not, air leaks will propagate to other bellows preventing us from generating a pressure difference and extending the time required to chuck a wafer. To overcome this cross-talk condition, a flow orifice can be used with each bellows. The orifice will produce individual time delays. The time delay can decrease the sensitivity to a neighboring bellows leak. This time delay can be tuned using a suitable orifice size and bellow volume. This tuning can allow reduction of the wafer throughput impact.

Providing a time delay to individual bellows can reduce the effects of cross talk. The time delay for each bellows can analogous to a capacitor resistor circuit, where the orifice is analogous to a resistor, and the bellows volume is analogous to a capacitor. The time delay has the form of ΔP=e^{-t/τ}, where τ=RC. The bellows capacitance can be derived from the ideal gas law. For example, the pneumatic capacitance C (kg/Pa) for a bellows can be defined as:

$$C = \frac{V}{rT} + \frac{P}{rT} \frac{{A}^{2}}{K}$$

where V is the bellow volume (m), r is the gas constant for air (J/kg*K), P is the initial pressure (Pa), T is the absolute temperature (K), A is the area of the bellows touching the wafer (m²), and K is the stiffness of the bellows (N/m).

It can be assumed that the process is isothermal. The pneumatic resistance R (Pa*sec/kg) can be defined as:

$$R = \frac{Δ P}{\dot{m}}$$

where ΔP is the pressure difference (Pa), and \dot{m} is the mass flow rate of air through an orifice (kg/sec).

The chuck internal pneumatic resistance may be small in comparison to the bellows orifice size. As an example, a bellow with a volume 9.3e-7 m³ and with an orifice of 100 μm would have a time constant τ=3.6 sec. To reduce the time constant τ, a larger orifice could be selected, e.g., 500 μm, resulting in a time constant of τ=0.14 sec. These numbers may be in line with measurements performed on tool.

The volumetric flow rate through an orifice for incompressible flow can be estimated as:

$${Q}_{bel} = {cA}_{0} \sqrt{\frac{2 Δ P}{ρ}}$$

where Q_{bel} is the volumetric flow rate per bellow (m³/s), c is the coefficient of discharge (dimensionless), A₀ is the cross-sectional area of orifice (m²), ΔP is the pressure drop across the orifice (Pa), and ρ is the density of the fluid (kg/m³).

The orifice size can be optimized using an iterative process. First, the required ΔP is found by dividing the force required to collapse the bellow against its own stiffness, F, by the area of the bellow, A_{bel}. Then, an orifice size is selected as an initial condition. The required volumetric flow rate required to create the necessary pressure drop across the selected orifice size is calculated. The flow rate calculated is the flow rate the vacuum source needs to supply each bellow. If the total flow rate required is greater than the vacuum source can achieve at the given pressure, then the orifice size is reduced, and the equation recalculated.

The vacuum chuck 100 may further comprise a processor 150. The processor 150 may include a microprocessor, a microcontroller, field programmable gate array (FPGA) or other devices. The processor 150 may be coupled to the components of the vacuum chuck 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with an inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the vacuum chuck 100 or another device. In an example, the processor 150 may be part of a standalone control unit or in a centralized quality control unit. Multiple processors 150 may be used, defining multiple subsystems of the vacuum chuck 100 or system.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the vacuum chuck 100 of system includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system or using images or data from other sources.

The processor 150 may be communicatively coupled to any of the various components or sub-systems of the system in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system or systems external to vacuum chuck 100. Various steps, functions, and/or operations of vacuum chuck 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system may include one or more computing or logic systems. Therefore, the above description should not be interpreted as a limitation on the present disclosure but merely an illustration.

The processor 150 may be in electronic communication with the at least one vacuum source 140. For example, the processor 150 may be configured to send instructions to open or close the one or more valves of the at least one vacuum source 140 to control vacuum flow through the one or more vacuum lines 145. Specifically, the processor 150 may be configured to send instructions to open a valve connected to the primary vacuum line 146 to control vacuum flow through the primary vacuum channel 113 and through internal volume 122 of each of the plurality of bellows and the opening 132 of each of the plurality of caps 130 to compress the plurality of bellows 120 into the compressed state and flatten the workpiece 101 onto the planar surface 111 of the chuck body 110. The processor 150 may be further configured to send instructions to open a valve connected to the secondary vacuum line 147 to control vacuum flow through the secondary vacuum channel 114 and through the external volume 115 each of the plurality of bellows 120 and through the plurality of apertures 112 of the chuck body 110 to simultaneously compress the plurality of bellows 120 into the compressed state without a workpiece 101 disposed on the planar surface 111 of the chuck body 110.

In some embodiments, the valve(s) controlling vacuum flow through the secondary vacuum line 147 may be closed when the valve(s) controlling vacuum flow through the primary vacuum line 146 are open. Furthermore, the valve(s) controlling vacuum flow through the primary vacuum line 146 may be closed when the valve(s) controlling vacuum flow through the secondary vacuum line 147 are open. Accordingly, the primary vacuum line 146 and the secondary vacuum line 147 may be used separately when chucking the workpiece 101 or compressing the plurality of bellows 120 without a workpiece 101, respectively.

With the vacuum chuck 100, the plurality of caps 130 provided on the plurality of bellows 120 may reduce particle accumulation on the back side of the workpiece 101 when the workpiece 101 is flattened onto the planar surface 111 of the chuck. In addition, the plurality of caps 130 may be configured to seal a secondary vacuum flow path provided by an exterior volume surrounding the plurality of bellows 120, which allows the plurality of bellows 120 to be compressed to the compressed state without a workpiece 101 disposed on the planar surface 111 of the chuck body 110, which can avoid possible collision during machine start up, periodic optical calibration, or maintenance. Furthermore, the plurality of orifices 118 reduce cross talk between the plurality of bellows 120, which can improve chucking performance of the chuck body 110.

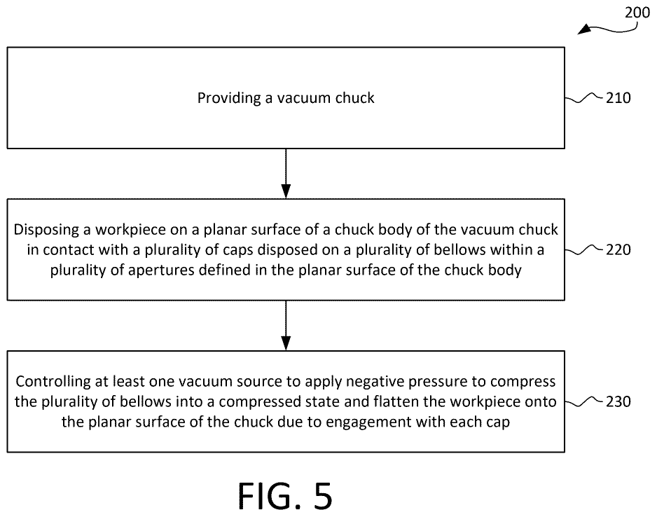

Another embodiment of the present disclosure provides a method 200. As shown in FIG. 5, the method 200 may comprise the following steps.

At step 210, a vacuum chuck is provided. The vacuum chuck may be, for example, the vacuum chuck 100 described above, the details of which are not repeated again here.

At step 220, a workpiece is disposed on a planar surface of a chuck body of the vacuum chuck in contact with a plurality of caps disposed on a plurality of bellows within a plurality of apertures defined in the planar surface of the chuck body. The workpiece is shown being disposed on the planar surface of the chuck body in contact with the plurality of caps, for example, in FIG. 2A.

At step 230 at least one vacuum source is controlled to apply negative pressure to compress the plurality of bellows into the compressed state and flatten the workpiece onto the planar surface of the chuck body due to engagement with each cap. The workpiece is shown being flattened onto the planar surface of the chuck body, for example, in FIG. 2B. A primary vacuum channel may be defined in the chuck body, and the at least one vacuum source may be in fluid communication with the plurality of apertures and the opening of each cap via the primary vacuum channel. Accordingly, the vacuum chuck can be used to flatten a workpiece onto the planar surface of the chuck body, with the plurality of caps that engage the workpiece producing a low particle count that reduces particle accumulation.

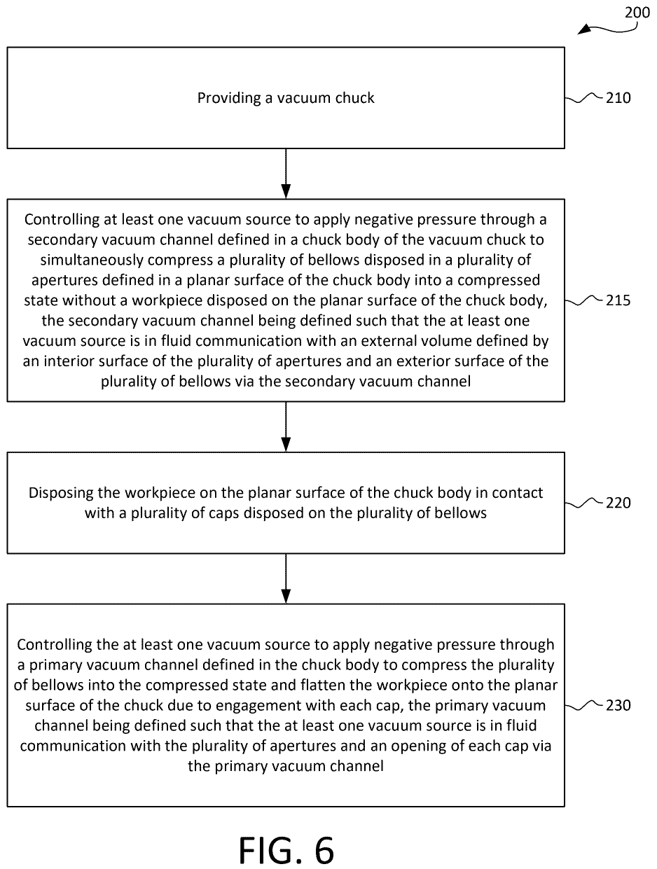

In some embodiments, before step 220, the method 200 may further comprise step 215, as shown in FIG. 6. At step 215, the at least one vacuum source is controlled to apply negative pressure through a secondary vacuum channel defined in the chuck body of the vacuum chuck to simultaneously compress the plurality of bellows into the compressed state without a workpiece disposed on the planar surface of the chuck body. For example, from the uncompressed state shown, for example, in FIG. 3A, the plurality of bellows can be compressed into the compressed state without a workpiece disposed on the planar surface of the chuck body, as shown, for example, in FIG. 3B. The secondary vacuum channel may be defined in the chuck body such that the at least one vacuum source is in fluid communication with an external volume defined by an interior surface of the plurality of apertures and an exterior surface of the plurality of bellows via the secondary vacuum channel. Accordingly, the vacuum chuck can compress the plurality of bellows into the compressed state to avoid collision with tool optics during calibration steps prior to a workpiece being disposed on the planar surface of the chuck body.

With the method 200, the plurality of caps provided on the plurality of bellows may reduce particle accumulation on the back side of the workpiece when the workpiece is flattened onto the planar surface of the chuck. In addition, the plurality of caps 130 may be configured to seal a secondary vacuum flow path provided by an exterior volume surrounding the plurality of bellows, which allows the plurality of bellows to be compressed to the compressed state without a workpiece disposed on the planar surface of a chuck, which can avoid possible collision during machine start up, periodic optical calibration, or maintenance. Furthermore, the plurality of orifices reduce cross talk between the plurality of bellows, which can improve chucking performance of the vacuum chuck.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A vacuum chuck comprising:
a chuck body having a planar surface and a plurality of apertures defined in the planar surface, wherein the planar surface is configured to support a workpiece;
a plurality of bellows disposed within the plurality of apertures, wherein the plurality of bellows are compressible such that the plurality of bellows protrude from the planar surface in an uncompressed state and are recessed from the planar surface in a compressed state;
a plurality of caps disposed on the plurality of bellows, wherein an opening is defined in a top surface of each cap, and the plurality of caps are substantially coplanar with the planar surface in the compressed state; and
at least one vacuum source in fluid communication with the plurality of apertures of the chuck body and the opening of each cap, wherein the at least one vacuum source is configured to apply negative pressure to compress the plurality of bellows into the compressed state and flatten the workpiece onto the planar surface of the chuck body due to engagement with each cap.

2. The vacuum chuck of claim 1, wherein the plurality of caps are made of an elastomeric material.

3. The vacuum chuck of claim 1, wherein a primary vacuum channel is defined in the chuck body, and the at least one vacuum source is in fluid communication with the plurality of apertures and the opening of each cap via the primary vacuum channel.

4. The vacuum chuck of claim 3, wherein a secondary vacuum channel is further defined in the chuck body, and the at least one vacuum source is in fluid communication with an external volume defined by an interior surface of the plurality of apertures and an exterior surface of the plurality of bellows via the secondary vacuum channel.

5. The vacuum chuck of claim 4, wherein the external volume is sealed from the planar surface of the chuck body by the plurality of caps in the compressed state, and the external volume is open to the planar surface in the uncompressed state.

6. The vacuum chuck of claim 5, wherein the plurality of apertures are counterbores, each defining an annular bearing surface, and a bottom surface of each cap rests on the annular bearing surface in the compressed state to seal the external volume from the planar surface of the chuck body in the compressed state.

7. The vacuum chuck of claim 4, wherein the at least one vacuum source comprises:
a first vacuum source in fluid communication with the primary vacuum channel; and
a second vacuum source in fluid communication with the secondary vacuum channel, wherein the second vacuum source is configured to apply negative pressure to compress the plurality of bellows into the compressed state without a workpiece disposed on the planar surface of the chuck body.

8. The vacuum chuck of claim 4, wherein the at least one vacuum source is further configured to apply negative pressure through the secondary vacuum channel to simultaneously compress the plurality of bellows into the compressed state without the workpiece disposed on the planar surface of the chuck body.

9. The vacuum chuck of claim 3, wherein an internal volume is defined in each of the plurality of bellows, the opening of each cap being in fluid communication with the primary vacuum channel via the internal volume of each bellow.

10. The vacuum chuck of claim 9, wherein a plurality of orifices are further defined in the chuck body, the plurality of orifices connecting each opening of the plurality of caps to the primary vacuum channel and being configured to restrict flow from each opening of the plurality of caps to the primary vacuum channel.

11. The vacuum chuck of claim 10, wherein the plurality of orifices are further configured to isolate each opening as each cap non-simultaneously engages with the workpiece and each bellow individually compresses to the compressed state.

12. A method comprising:
providing a vacuum chuck, comprising:
a chuck body having a planar surface and a plurality of apertures defined in the planar surface, wherein the planar surface is configured to support a workpiece;
a plurality of bellows disposed within the plurality of apertures, wherein the plurality of bellows are compressible such that the plurality of bellows protrude from the planar surface in an uncompressed state and are recessed from the planar surface in a compressed state;
a plurality of caps disposed on the plurality of bellows, wherein an opening is defined in a top surface of each cap, and the plurality of caps are substantially coplanar with the planar surface in the compressed state; and
at least one vacuum source in fluid communication with the plurality of apertures of the chuck body and the opening of each cap;
disposing the workpiece on the planar surface of the chuck body in contact with the plurality of caps; and
controlling the at least one vacuum source to apply negative pressure to compress the plurality of bellows into the compressed state and flatten the workpiece onto the planar surface of the chuck body due to engagement with each cap.

13. The method of claim 12, wherein a primary vacuum channel is defined in the chuck body, and the at least one vacuum source is in fluid communication with the plurality of apertures and the opening of each cap via the primary vacuum channel.

14. The method of claim 13, wherein before disposing the workpiece on the planar surface of the chuck body in contact with the plurality of caps, the method further comprises:
controlling the at least one vacuum source to apply negative pressure through a secondary vacuum channel to simultaneously compress the plurality of bellows into the compressed state without the workpiece disposed on the planar surface of the chuck body;
wherein the secondary vacuum channel is defined in the chuck body such that the at least one vacuum source is in fluid communication with an external volume defined by an interior surface of the plurality of apertures and an exterior surface of the plurality of bellows via the secondary vacuum channel.

15. The method of claim 14, wherein the external volume is sealed from the planar surface of the chuck body by the plurality of caps in the compressed state, and the external volume is open to the planar surface in the uncompressed state.

16. The method of claim 15, wherein the plurality of apertures are counterbores, each defining an annular bearing surface, and a bottom surface of each cap rests on the annular bearing surface in the compressed state to seal the external volume from the planar surface of the chuck body in the compressed state.

17. The method of claim 14, wherein the at least one vacuum source is controlled to apply negative pressure through the secondary vacuum channel to simultaneously compress the plurality of bellows into the compressed state without the workpiece disposed on the planar surface of the chuck body.

18. The method of claim 13, wherein an internal volume is defined in each of the plurality of bellows, the opening of each cap being in fluid communication with the primary vacuum channel via the internal volume of each bellow.

19. The method of claim 13, wherein a plurality of orifices are further defined in the chuck body, the plurality of orifices connecting each opening of the plurality of caps to the primary vacuum channel and being configured to restrict flow from each opening of the plurality of caps to the primary vacuum channel.

20. The method of claim 19, wherein the plurality of orifices are further configured to isolate each opening as each cap non-simultaneously engages with the workpiece and each bellow individually compresses to the compressed state.
